(19) United States
(12) Patent Application Publication
(10) Pub. No.: US 2025/0282443 A1
(43) Pub. Date: Sep. 11, 2025

(54) Steering Stabilization System for Bicycle Handlebars

(71) Applicant: Canyon Bicycles GmbH, Koblenz (DE)

(72) Inventor: Johannes Thumm, Lörrach (DE)

(21) Appl. No.: 19/055,993

(22) Filed: Feb. 18, 2025

(30) Foreign Application Priority Data
Mar. 8, 2024 (DE) 20 2024 101 154.6

(51) Int. Cl. B62K 21/10; B62K 19/32; B62K 19/40

(52) U.S. Cl. CPC B62K 21/10; B62K 19/32; B62K 19/40

(57) ABSTRACT

A steering stabilization system for bicycle handlebars has a steer tube pivotably mounted within a head tube. A first magnetic device is connected to the steer tube in a non-rotatable manner. A second magnetic device is connected to the head tube so that it cannot rotate. The two magnetic devices have at least one diametrically magnetized ring magnet and are arranged relative to each other in such a way that a return torque is generated when the steer tube is rotated from a rest position.

### CROSS-REFERENCE TO RELATED APPLICATION

This application claims priority to German Patent Application No. 20 2024 101 154.6, filed Mar. 8, 2024, the disclosure of which is hereby incorporated by reference in its entirety.

### BACKGROUND OF THE INVENTION

### Field of the Invention

The invention relates to a steering stabilization system for bicycle handlebars.

### Description of Related Art

To improve the riding characteristics of a bicycle and in particular to reduce external influences such as bumps and the like on the steering, it is known to provide steering stabilization systems. Such systems are described, for example, in DE 10 2021 006 577, DE 10 2021 005 463 and DE 10 2021 006 508. Such known steering stabilization systems comprise in particular two springs arranged in the top tube of the bicycle frame, each of which is connected via a band to a cam ring fixed to the steer tube. When the handlebar is turned, one of the springs is tensioned and a return torque is generated. The return torque moves the handlebar back to the initial or rest position. The rest position is the position in which the handlebar is when riding straight ahead.

However, known steering stabilization systems have the disadvantage that they require a relatively large amount of space. In this respect, the use of known steering stabilization systems in narrow frames, which in particular have a top tube with small external dimensions, is not possible. On the other hand, the use of steering stabilization systems would also be desirable for bicycles of this type, such as racing bikes or time trial bikes in particular. Another problem with known steering stabilization systems is that the arrangement of the springs in the top tube hinders the routing of cables within the frame tubes, especially within the top tube, and in some cases cannot be implemented.

The task of the invention is to create a steering stabilization system for bicycle handlebar that requires little space.

### SUMMARY OF THE INVENTION

The object is achieved, according to the invention, with a steering stabilization system having the features as described herein.

The steering stabilization system according to the invention for bicycle handlebars comprises a steer tube which is pivotably mounted in a head tube. In particular, the steer tube is pivotably mounted on the head tube by means of an upper and a lower bearing element. A first magnetic device is non-rotatably connected to the steer tube. The first magnetic device can be directly or indirectly connected to the steer tube in a non-rotatable manner. For example, the first magnetic device could also be arranged in the area of the fork bridge or in the area of a handlebar stem. A second magnetic device is connected to the head tube in a non-rotatable manner. Again, an indirect connection to the head tube is possible, so that the second magnetic device can also be connected to another frame element, such as a down tube or a top tube. Each magnetic device has at least one diametrically magnetized ring magnet. Furthermore, the magnetic devices are arranged in relation to each other in such a way that a return torque is generated when the steer tube is turned from a rest position, i.e. when the handlebar is turned from a straight-ahead position. The return torque results from the twisting of the two solenoid devices in relation to each other.

By providing two such magnetic devices in accordance with the invention, it is possible to create a steering stabilization system that requires very little space. The use of magnetic devices also has the advantage that they are not subject to any or at least less ageing than springs. It is also possible to realize a contactless steering stabilization system by providing magnetic devices, so that no wear occurs and negative influences due to friction or the like are avoided.

Preferably, the two magnet devices comprise permanent magnets, wherein it is particularly preferred that only permanent magnets are provided. Alternatively, one or both magnet devices can also comprise at least one solenoid. By providing a solenoid, it is possible to easily switch the steering stabilization system on or off. If a solenoid is provided, it is necessary to connect the solenoid to an energy source, such as the battery of an e-bike. In addition to the on/off switch, a control device can also be provided. The control device could, for example, be used to automatically switch the steering stabilization system on and off depending on the driving situation, such as speed, uneven surface, etc.

The ring magnets are preferably of multipolar design, in particular of a four-pole design. Depending on the number of pole pairs, a maximum torque or return torque is generated at a different angle of rotation or steering angle of the handlebar. When using ring magnets with a pair of poles, i.e. a ring magnet with half a ring as the north pole and half a ring as the south pole, the maximum torque is reached at a rotation angle or steering angle of 90°. When using four-pole magnets, i.e. ring magnets with two pole pairs, the maximum torque is reached at an angle of 45°. Typical steering angles are in the range of 75° to 80°. The torque curve of the return torque corresponds to a flattened sine curve. Depending on the design of the ring magnets used, the maxima of the curve are approx. 15° and 75°. A sharp drop in the torque resetting the handlebar only occurs from approx. 80°, i.e. in a range in which the handlebar is not normally turned. By providing a steering stop, it is possible to prevent the handlebar from being steered in a range in which the return torque would be negative. A corresponding steering stop could, for example, also be integrated directly into the steering stabilization system according to the invention by means of a positive connection.

It is also possible to design individual or all of the ring magnets used as magnet arrays consisting of individual segment magnets. The use of a Halbach array is particularly preferred here.

The two magnetic devices can be located in different areas of the bicycle. It is particularly preferred that the first and/or second magnetic device is arranged inside the head tube. It is particularly preferable for both magnet devices to be arranged inside the head tube. It is again preferable that the two magnet devices are arranged in the lower area, i.e. close to the lower bearing. The advantage of this is that cables can be easily routed from the handlebar via a handlebar stem into the steer tube or head tube and from there into the top tube. This also makes it possible to easily insert cables between the upper headset and the steer tube into the head tube and then arrange them in the down tube.

The ring magnets of the two magnetic devices can be arranged axially to each other. In particular, the ring elements are arranged coaxially to each other. It is particularly preferred that the ring magnets surround the steer tube and are arranged one above the other in the axial direction of the steer tube. In this case, the at least one ring magnet of the first magnetic device can be connected to the steer tube in a simple way, for example by clamping, gluing or other fixing options. The at least one ring magnet of the second magnetic device could also be fixed to the inside of the head tube by clamping or gluing. However, a detachable fixation with the aid of a retaining element or similar is preferred. In this manner, assembly is simplified. It is preferable that such a retaining element can be detached or fixed from the outside.

It is also possible for the ring magnets to be arranged radially to each other. It is again preferable for the ring magnets to be arranged coaxially to one another, with an outer ring magnet surrounding an inner ring magnet. The ring magnets preferably surround the steer tube. In this embodiment, the inner ring magnet is part of the first magnetic device or forms part of it and is in turn connected to the steer tube in a rotationally fixed manner, for example by gluing, clamping or the like. The outer ring magnet is part of the second magnetic device or forms the same. The outer ring magnet is then connected to the head tube via a detachable retaining element to prevent it from rotating.

In another preferred embodiment, the return torque can be changed. When using a solenoid, this is possible by varying the magnetic strength of the solenoid. If permanent magnets are used, the magnitude of the return torque can be varied by changing the position of the magnetic devices in relation to each other. In particular, the two magnetic devices or parts of individual magnetic devices can be moved relative to each other. With axially arranged ring magnets, the maximum return torque can be changed by changing the air gap between neighboring ring magnets. With radially arranged ring magnets, a change in the return torque can be varied by changing the engagement depth of the two ring magnets. In particular, it is preferable that the magnet device arranged directly or indirectly on the head tube is displaceable. This can be effected in particular with the aid of the retaining element, which is provided for attaching the second magnetic device to the head tube or to another frame element. The shape of the torque curve can also be changed, for example, by using different material thicknesses for the magnets. When using magnet arrays, this is made possible by the positioning and pole direction of the individual segment magnets.

In another preferred embodiment, it is possible to deactivate the steering stabilization system. If at least one electromagnet is used, this is possible by simply switching it off. When using permanent magnets, deactivation can be achieved, for example, by loosening the connection between the second magnetic device and the head tube or another frame element, causing the second magnetic device to rotate. The connection is preferably released without tools or with simple tools such as an Allen key or similar.

### BRIEF DESCRIPTION OF THE DRAWINGS

The terms Fig., Figs., Figure, and Figures are used interchangeably in the specification to refer to the corresponding figures in the drawings.

In the following, the invention is described in more detail by means of a preferred embodiment with reference to the accompanying drawings.

In the Figures:

FIG. 1 is a schematic perspective view of magnetic devices arranged axially to one another,

FIG. 2 is a schematic perspective view of magnetic devices arranged axially to one another,

FIG. 3 is a schematic sectional view of a steering stabilization system according to the invention.

### DESCRIPTION OF THE INVENTION

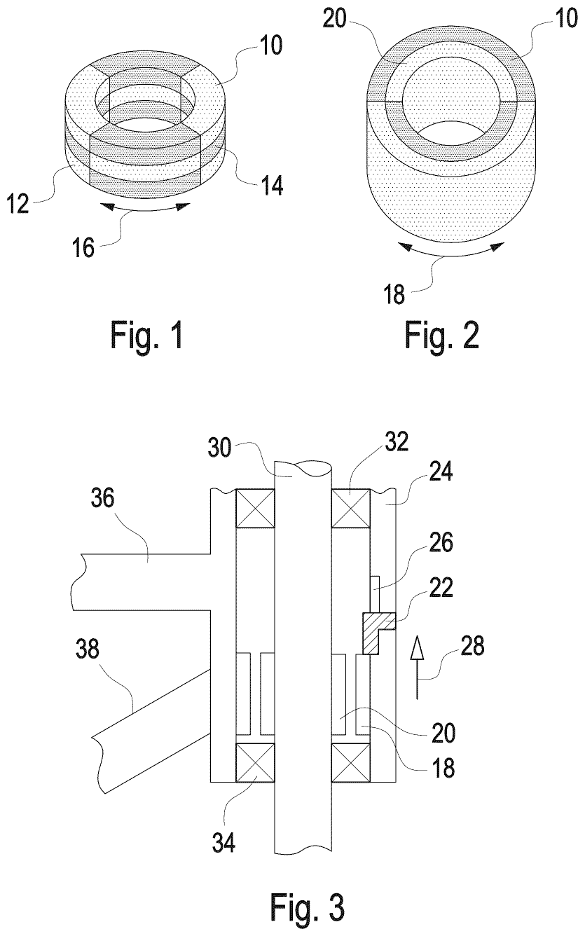

In the embodiment shown in FIG. 1, a first magnetic device comprises two ring magnets 10, 12, each with two pairs of poles, which are shown by different hatching. A further ring magnet 14, which forms the second magnetic device, is arranged between the two ring magnets forming the first magnetic device. The ring magnet 14 also has four poles. One of the two magnetic devices, in particular the first magnetic device, is arranged on the steer tube, in particular connected to the steer tube in a non-rotatable manner by bonding or clamping. The second magnetic device 14 is held on the head tube, in particular connected in a non-rotatable manner. By turning the two ring magnets 10, 12 connected to the steer tube in the direction of an arrow 16, the ring magnets 10, 12, 14 are turned from their rest position so that a return torque is generated. This return torque causes the steer tube and therefore the handlebar to rotate back to the rest position or supports this rotational movement.

Accordingly, FIG. 2 shows a system with radially arranged ring magnets 18, 20. The inner ring magnet 20 forms the first magnetic device, which is connected to a steer tube in a non-rotatable manner. The second magnetic device is formed by the outer ring magnet 18, which is non-rotatably connected to the head tube. Turning the steer tube and thus the inner ring magnet 20 connected to the steer tube in the direction of the arrow 16 again generates a return torque.

In the embodiment of the invention shown in FIG. 3, the embodiment of the magnetic devices 18, 20 shown in FIG. 2 is shown in the installed state. The outer ring magnet 18, which forms the second magnetic device in the illustrated embodiment example, is non-rotatably connected to the head tube 24 via a retaining element 22. The retaining element 22 is firmly connected to the magnetic ring 18 and is arranged in a groove 26 provided on the inside of the head tube 24, or engages in the groove 26. The retaining element is accessible from the outside through an outward opening in the head tube 24 and can be fixed, for example, by a clamping element such as a grub screw. To set the maximum return torque that can be generated, the outer ring magnet 18 can be moved upwards in the direction of an arrow 28 in FIG. 3, so that the depth of engagement of the two ring magnets 18, 20 changes.

Within the head tube 24, a steer tube 30 is pivotably mounted via an upper bearing element 32 and a lower bearing element 34. As shown schematically, a top tube 36 and a down tube 38 are also connected to the head tube 34.

The inner ring magnet 20 is arranged inside the head tube 24 and is connected to the steer tube 30 in a non-rotatable manner. This can be effected, for example, with the aid of a clamped connection by gluing or other types of connection. In the embodiment illustrated in FIG. 3, the two magnetic devices 18, 20, which are formed by the two ring magnets 18, 20 in the illustrated embodiment, are arranged in a lower region of the head tube 24, i.e. near the lower bearing element 34. This has the advantage that cables coming from the handlebar, for example, can be easily routed inside the top tube.

1. A steering stabilization system for bicycle handlebars, comprising:
a head tube,
a steer tube pivotably mounted in the head tube,
a first magnetic device connected to the steer tube in a rotationally fixed manner, and
a second magnetic device connected to the head tube in a non-rotatable manner,
wherein each magnetic device comprises at least one diametrically magnetized ring magnet and the magnetic devices are arranged relative to one another in such a way that a return torque is produced when the steer tube is rotated from a rest position.

2. The steering stabilization system for bicycle handlebars according to claim 1, wherein both magnetic devices comprise permanent magnets.

3. The steering stabilization system for bicycle handlebars according to claim 1, wherein one or both magnetic devices comprise at least one solenoid.

4. The steering stabilization system for bicycle handlebars according to claim 1, wherein the ring magnets are of multipolar design, in particular a four-pole design.

5. The steering stabilization system for bicycle handlebars according to claim 1, wherein the ring magnets are designed as a magnet array consisting of individual segment magnets.

6. The steering stabilization system for bicycle handlebars according to claim 1, wherein the first and/or the second magnetic device are arranged inside the head tube.

7. The steering stabilization system for bicycle handlebars according to claim 1, wherein the ring magnets are arranged axially relative to one another, in particular surrounding the steer tube.

8. The steering stabilization system for bicycle handlebars according to claim 1, wherein the ring magnets are arranged radially relative to one another, in particular surrounding the steer tube.

9. The steering stabilization system for bicycle handlebars according to claim 1, wherein the magnetic devices are displaceable relative to one another in order to change the return torque.

10. The steering stabilization system for bicycle handlebars according to claim 1, wherein the connection between the second magnetic device and the head tube is detachable.
